(19) United States
(12) Patent Application Publication
(10) Pub. No.: US 2023/0050430 A1
(43) Pub. Date: Feb. 16, 2023

(54) ROBOTIC PROCESS AUTOMATION SYSTEM FOR MANAGING HUMAN AND ROBOTIC TASKS

(71) Applicant: Automation Anywhere, Inc., San Jose, CA (US)

(72) Inventors: Nicolas Piau, Paris (FR); Perv Rastogi, San Jose, CA (US); Geoffrey Laissus, Sunnyvale, CA (US)

(21) Appl. No.: 17/557,741

(22) Filed: Dec. 21, 2021

Related U.S. Application Data
(60) Provisional application No. 63/231,695, filed on Aug. 10, 2021.

(51) Int. Cl. B25J 9/16

(52) U.S. Cl. CPC B25J 9/1661; B25J 9/161; B25J 9/163

(57) ABSTRACT

Improved techniques for combining human tasks and robotic tasks in an organized manner to define an automation workflow process. A workflow process platform can assist a developer in creating an automation workflow process, and/or manage performance of an automation workflow process. The improved techniques enable a Robotic Process Automation (RPA) system to support programmatically combining various robotic tasks with human actions to provide an interrelated relationship of both human tasks and automated tasks.

### CROSS-REFERENCE TO RELATED APPLICATION

This application claims priority to U.S. patent provisional Application No. 63/231,695, filed Aug. 10, 2021, and entitled “ROBOTIC PROCESS AUTOMATION FOR MANAGING HUMAN AND ROBOTIC TASKS,” which is hereby incorporated herein by reference.

### BACKGROUND OF THE INVENTION

Robotic Process Automation (RPA) systems enable automation of repetitive and manually intensive computer-based tasks. In an RPA system, computer software, namely a software robot (often referred to as a “bot”), may mimic the actions of a human being in order to perform various computer-based tasks. For instance, an RPA system can be used to interact with one or more software applications through user interfaces, as a human being would do. Therefore, RPA systems typically do not need to be integrated with existing software applications at a programming level, thereby eliminating the difficulties inherent to integration. Advantageously, RPA systems permit the automation of application level repetitive tasks via software robots that are coded to repeatedly and accurately perform the repetitive task.

RPA systems have generally assisted users in creating software robots that mimic user interactions with software applications to perform various tasks. These software robots are normally used to automate tasks for a particular user. However, tasks are often combined to perform a process that involves various different departments or persons of an enterprise. Conventionally, software robots are used in an isolated manner for particular users, and thus are not easily used in combination, especially when various users and/or client machines are involved. As such, although software robots can be utilized to carry out tasks, there remains inefficiencies and complications in carrying out automated processing across different users, departments, or businesses.

Therefore, there is a need for improved approaches to utilize software robots for RPA systems in an interrelated manner, especially when involving various users and various computing machines.

### SUMMARY

Embodiments disclosed herein concern improved techniques for combining human tasks and robotic tasks in an organized manner to define an automation workflow process. A workflow process platform can assist a developer in creating an automation workflow process, and/or manage performance of an automation workflow process. The automation workflow process can carry out a process, such as a business process, by interrelating human tasks performed by users with robotic tasks performed by computing machines. The workflow process platform can be network-based and utilize various users and computing machines that are affiliated with different groups (e.g., teams, departments) of an organization. Advantageously, the improved techniques can enable automation of business processes using various persons and robotic agents in an organized and controlled manner.

The invention can be implemented in numerous ways, including as a method, system, device, apparatus (including computer readable medium and graphical user interface). Several exemplary embodiments of the invention are discussed below.

As a computer-implemented method for interrelating software robots of a robotic process automation system to carry out an automation workflow process, one embodiment can, for example, include at least: identifying an automation workflow process to be performed, the automation workflow process including a sequence of tasks, the tasks including at least (i) one or more human tasks and (ii) one or more robotic tasks; determining a first task within the automation workflow process that is to be performed; causing the first task to be performed on a first computing device; receiving an indication that the first task has completed; determining a subsequent task within the automation workflow process that is to be performed after the first task; causing the subsequent task to be performed on a second computing device; and receiving an indication that the subsequent task has completed.

As a computer-implemented method for interrelating software robots of a robotic process automation system to carry out an automation workflow process, one embodiment can, for example, include at least: identifying a first robotic task to be included in the automation workflow process being created; configuring the first robotic task to utilize a first software robot to obtain output data; identifying a first human task to be included in the automation workflow process being created; arranging the first human task to follow after the first robotic task within the automation workflow process; configuring the first human task to present a user interface to a person, wherein the user interface is used to present at least a portion of the output data obtained by the first robotic task.

As a non-transitory computer readable medium including at least computer program code tangible stored thereon for interrelating software robots of a robotic process automation system to carry out an automation workflow process, one embodiment can, for example, include at least: computer program code for identifying an automation workflow process to be performed, the automation workflow process including a sequence of tasks, the tasks including at least (i) one or more human tasks and (ii) one or more robotic tasks; computer program code for determining a first task within the automation workflow process that is to be performed; computer program code for causing the first task to be performed on a first computing device; computer program code for receiving an indication that the first task has completed; computer program code for determining a subsequent task within the automation workflow process that is to be performed after the first task; computer program code for causing the subsequent task to be performed on a second computing device; and computer program code for receiving an indication that the subsequent task has completed.

As a computer-implemented method for interrelating software robots of a robotic process automation system to create an automation workflow process, one embodiment can, for example, include at least: identifying a first human task to be included in the automation workflow process being created; configuring the first human task to present a user interface to a person and to capture a data input therefrom; identifying a first robotic task to be included in the automation workflow process being created; arranging the first robotic task to follow after the first human task within the automation workflow process; and configuring the first robotic task to perform a first software robot, and to receive as an input at least a portion of the data input that the first human task provided.

As a non-transitory computer readable medium including at least computer program code tangible stored thereon for interrelating software robots of a robotic process automation system to create an automation workflow process, one embodiment can, for example, include at least: computer program code for identifying a human task to be included in the automation workflow process being created; computer program code for configuring the human task to present a user interface to a person and to capture a data input therefrom; computer program code for identifying a robotic task to be included in the automation workflow process being created; computer program code for arranging the robotic task to follow after the human task within the automation workflow process; and computer program code for configuring the robotic task to perform a software robot.

As a robotic process automation system, one embodiment can, for example, include at least a data store and a workflow process platform. The data store can be configured to store a plurality of software robots. The software robots can provide automated interaction with one or more software programs operating on one or more computing devices. The workflow process platform can be configured to enable users to (i) create automation workflow processes, and (ii) perform automation workflow processes that have been created. At least a particular automation workflow process of the created automation workflow processes can include a determined sequence of performing a plurality of tasks, wherein at least one of the tasks in the determined sequence being a robotic task that is performed by one of the software robots, and at least another of the tasks in the determined sequence being a human task that is performed to receive interaction with a person. When the particular automation workflow process is performed, the tasks of the particular automation workflow process in the determined sequence are performed, and such performance can cause the one of the software robots for the robotic task to be performed and cause a user interface to be presented to the person in performing the human task.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a diagram of an RPA environment according to one embodiment.

FIG. 2 illustrates a block diagram of a workflow process platform according to one embodiment.

FIG. 3 is a flow diagram of a workflow execution process according to one embodiment.

FIG. 4 is a flow diagram of a workflow coordination process according to one embodiment.

FIG. 5 illustrates a block diagram of an RPA system according to one embodiment.

FIG. 6 is a block diagram of a distributed workflow process according to one embodiment.

FIG. 7 is a block diagram of an employee onboarding workflow process according to one embodiment.

FIGS. 8A-8D are exemplary screenshots of configuration screens that can be used to configure operation of an automation workflow process, according to one embodiment.

FIG. 9 is s screenshot of an exemplary form that can be present to a person in content of a human task, according to one embodiment.

FIG. 10 is a block diagram of an RPA system according to one embodiment.

FIG. 11 is a block diagram of a generalized runtime environment for bots in accordance with another embodiment of the RPA system illustrated in FIG. 10.

FIG. 12 illustrates yet another embodiment of the RPA system of FIG. 10 configured to provide platform independent sets of task processing instructions for bots.

FIG. 13 is a block diagram illustrating details of one embodiment of the bot compiler illustrated in FIG. 12.

FIG. 14 illustrates a block diagram of an exemplary computing environment for an implementation of an RPA system, such as the RPA systems disclosed herein.

### DETAILED DESCRIPTION OF CERTAIN EMBODIMENTS

Embodiments disclosed herein concern improved techniques for combining human tasks and robotic tasks in an organized manner to define an automation workflow process. A workflow process platform can assist a developer in creating an automation workflow process, and/or manage performance of an automation workflow process. The improved techniques enable an RPA system to support programmatically combining various robotic tasks with human actions to provide an interrelated relationship of both human tasks and automated tasks.

An automation workflow process can carry out a process, such as a business process. By interrelating human tasks performed by users with robotic tasks performed by computing machines, the workflow process platform can be network-based and utilize various users and computing machines that are affiliated with different groups (e.g., teams, departments) of an organization. Advantageously, the improved techniques can enable automation of business processes using various persons and robotic agents in an organized and controlled manner.

Generally speaking, RPA systems use computer software to emulate and integrate the actions of a human interacting within digital systems. In an enterprise environment, these RPA systems are often designed to execute a business process. In some cases, the RPA systems use Artificial Intelligence (AI) and/or other machine learning capabilities to handle high-volume, repeatable tasks that previously required humans to perform. The RPA systems support a plurality of software robots. More specifically, the RPA systems provide for creation, configuration, management, execution, monitoring, and performance of software robots.

Software robots can also be referred to as robotic agents, software agents, or bots. A software robot can interpret and execute tasks on your behalf. Software robots are particularly well suited for handling a lot of the repetitive tasks that humans perform every day. Software robots can perform a task they are tasked with and do it consistently and reliably each time. As one example, a software automation process can locate and read data in a document, email, file, or window. As another example, a software robot can connect with one or more Enterprise Resource Planning (ERP), Customer Relations Management (CRM), core banking, and other business systems to distribute data where it needs to be in whatever format is necessary. As another example, a software robot can perform data tasks, such as reformatting, extracting, balancing, error checking, moving, copying, and the like. As another example, a software robot can grab data desired from a webpage, application, screen, file, or other data source. As still another example, a software robot can be triggered based on time or an event, and can serve to take files or data sets and move them to another location, whether it is to a customer, vendor, application, department, or storage.

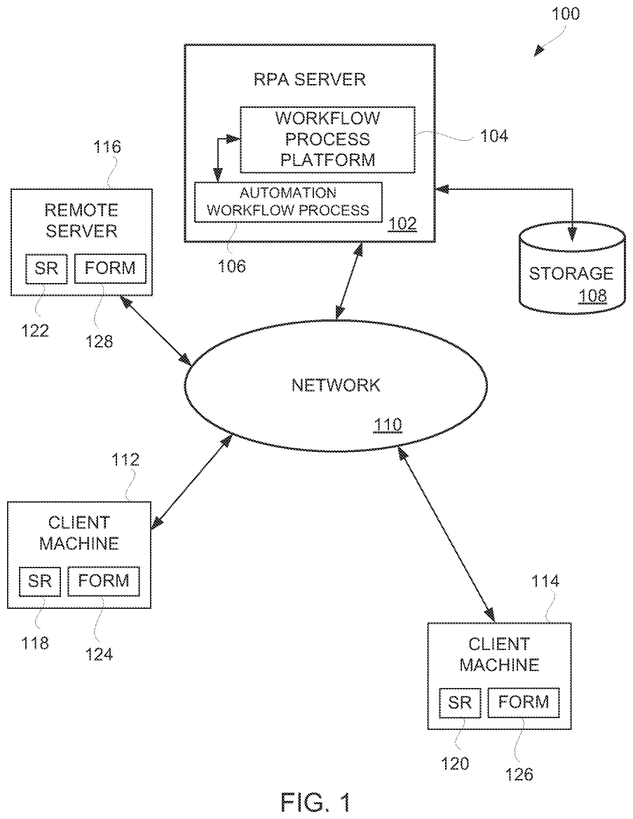

Embodiments of various aspects of the invention are discussed below with reference to FIGS. 1-14. However, those skilled in the art will readily appreciate that the detailed description given herein with respect to these figures is for explanatory purposes as the invention extends beyond these limited embodiments.

FIG. 1 is a diagram of an RPA environment 100 according to one embodiment. The RPA environment 100 includes an RPA server 102. The RPA server 102 supports a workflow process platform 104. The workflow process platform 104 can facilitate creation, storage and performance of automation workflow processes 106. For example, the workflow process platform 104 can carry out a process, such as a business process. More particularly, the process to be carried out by the workflow process platform 104 can by defining an automation workflow process 106 that identifies a series of tasks, whether provided by humans or by software robots (i.e., robotic agents), that together are used to carry out the process. The automation workflow platform can then perform (e.g., execute) the automation workflow process 106 in which case the series of tasks that carry out the process are performed. The automation workflow process 106 defines tasks to be performed, exchange data amongst the tasks, and condition logic for added robustness. The automation workflow process 106 is a computer readable description that can be interpreted by the computing device operating the workflow process platform 104 or can be compiled in executable process code that can be executed by the computing device operating the workflow process platform 104.

The RPA environment 100 is typically operated over a plurality of different computing devices that can be associated with different departments of an organization, different locations of an organization, different users, or even different organizations. These different computing devices can interact with one another via a network 110. As examples, the RPA environment 100 can include client machine 112, client machine 114, and remote server 116. The computing devices can, for example, be desktop computers, personal computers, server computers, laptops, tablets, and any other known portable computing devices. The RPA environment 100 can also couple to a storage unit 108 that can store a plurality of automation workflow processes and/or software robots. The storage unit 108 can provide local storage or central repository storage.

In carrying out the automation workflow process 106, the workflow process platform 104 can activate tasks on any of the different computing devices. Each task can be a human task or a robotic (or “bot”) task. The robotic task is an automated task carried out by a software robot (or robotic agent). Additionally, the workflow process platform 104 can also utilize processing at the RPA server 102 to control, manage and monitor performance of the automation workflow process 106.

As illustrated in FIG. 1, the client machine 112 can support a human task that can present a user interface, or a robotic task that can utilize a software robot 118. Similarly, the client machine 114 can support a human task that can present a user interface, or a robotic task that can utilize a software robot 120. Further still, the remote server 116 can utilize a software robot 122 to perform robotic tasks.

The robotic tasks may be performed by software robots 118, 120, 122. The software robots 118, 120, 122 for the robotic tasks to be carried out can reside locally at the client machine 112, 114 or server 116, or can be retrieved from the workflow process platform 104 or a central repository (e.g., storage 108). In one example, the RPA server 102 can include or couple to a central repository for software robots. The RPS server 102 can also support a RPS system that permits creation of software robots.

The human tasks are tasks that involves human interaction. In one implementation, a human task can be to present a graphical user interface to a user that displays an electronic form 124, 126, 128 on a display. A user can interact with the form 124, 126, 128 to enter information that can be submitted back to the workflow flow process platform 104. The forms 124, 126, 128 used for human tasks can also reside locally at the client machine 112, 114 or server 116, or can be retrieved from the workflow process platform 104 or a central repository. In one example, the RPA server 102 can include or couple to a central repository (e.g., storage 108) for the form.

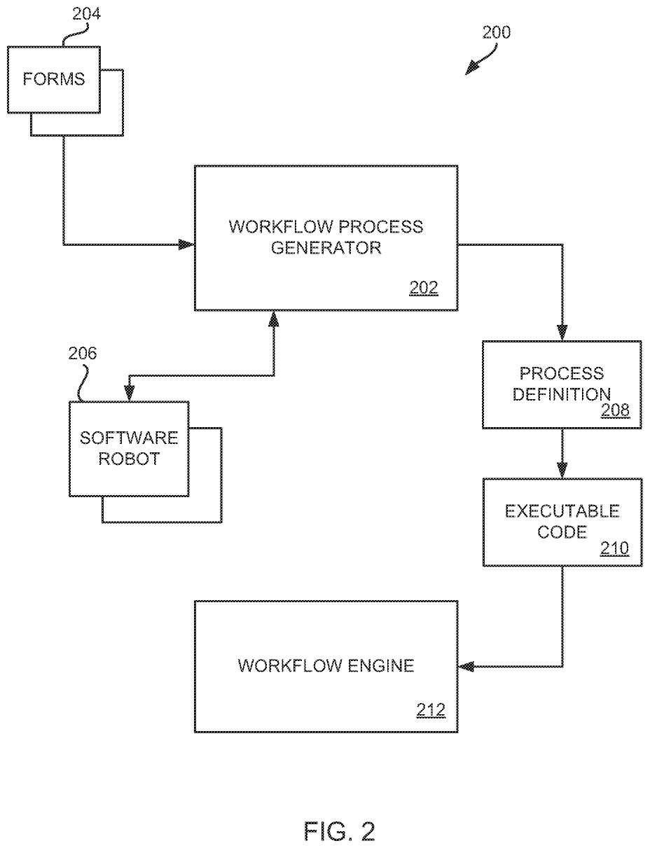

FIG. 2 illustrates a block diagram of a workflow process platform 200 according to one embodiment. The workflow process platform 200 can, for example, pertained to the workflow process platform 104 illustrated in FIG. 1.

The workflow process platform 200 can include a workflow process generator 202. The workflow process generator 202 is configured to enable a user to generate an automation workflow process. In doing so, the user can create and or select one or more forms 204 to be utilized in the automation workflow process. Additionally, the user can create and or select one or more software robots 206 (robotic agents) to be utilized in the automation workflow process. Further still, the user can additionally include process flow logic (e.g., conditional logic), such as checkpoints, branches or validations, that are to occur in the automation workflow process. As a result, the workflow process generator 202 can yield an automation workflow process that is defined by a process definition 208. As an example, the process definition 208 for an automation workflow process can have a JavaScript Object Notation (JSON) format. JSON is a standard text-based format for representing structured data based on JavaScript object syntax.

Additionally, the workflow process platform 200 can compile the process definition 208 to yield executable code 210. The process definition 208 or the executable code 210 can be later executed by the workflow process platform 200 to carry out the automation workflow process. The workflow process platform 200 can also include a workflow engine 212. The workflow engine 212 can carry out the automation workflow process. To do so, the workflow engine 212 can interpret and perform the process definition 208 or can execute the executable code 210.

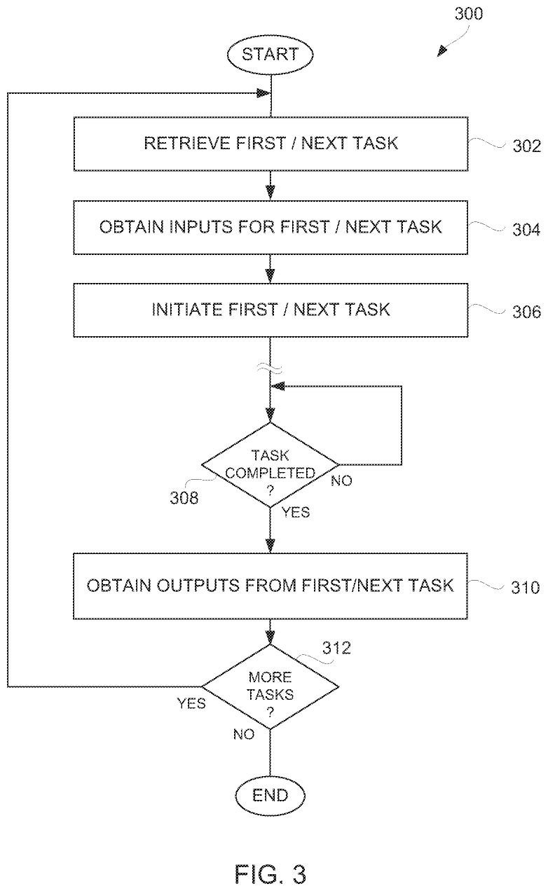

FIG. 3 is a flow diagram of a workflow execution process 300 according to one embodiment. The workflow execution process 300 is, for example, performed by a workflow process platform, such as the workflow process platform 104 illustrated in FIG. 1.

The workflow execution process 300 carries out an automation workflow process that has previously been created. The workflow execution process 300 can retrieve 302 a first task of the automation workflow process being performed. In addition, any inputs needed for the first task can be obtained 304. Thereafter, the first task can be initiated 306. Here, the workflow execution process 300 can request that a particular computing device perform the first task. The particular computing device would be a computing device associated to a user, department, team of users, etc. For example, if the automation workflow process concerns approval of a purchase order, then the first task might be for a user in the sales department to specify a purchase order number for the purchase order that is to be approved.

At this point, the workflow execution process 300 is not required to do anything until the first task indicates that it has completed its task. In other words, the workflow execution process 300 can be stateless and thus need not continuously monitor or await the completion of the first task. For example, in the example where the first task seeks input from a user in the sales department, that might take seconds, minutes, hours or days. During such undetermined time, the workflow execution process 300 can be inactive. In other words, the execution of the automation workflow process by the workflow execution process 300 operates asynchronously.

However, after the first task reports back to the workflow execution process 300 that it has been completed, as detected by decision 308, the workflow execution process 300 can obtain 310 any outputs from the first task. Thereafter, a decision 312 can determine whether the automation workflow process has any additional tasks that are to be performed.

When the decision 312 determines that there are more tasks to be performed, then the workflow execution process 300 can return to the block 302 and subsequent blocks so that a next task within the particular workflow process can be carried out in a similar fashion. As such, the workflow execution process 300 can retrieve 302 a next task of the automation workflow process being performed. Then, any inputs needed for the next task can be obtained 304. Thereafter, the next task can be initiated 306. Here, the workflow execution process 300 can request that a particular computing device perform the next task. The particular computing device would be a computing device associated with a user, department, team of users, etc. For example, if the automation workflow process concerns automated processing of the purchase order to import its details into a database, then the next task might be to launch a software robot (robotic agent) using a computing device in sales department to carry out the importing of the purchase order details into a database. Again, the workflow execution process 300 is not required to do anything until the software robot completes its task. Once the next task reports back to the workflow execution process 300 that it has been completed, as detected by the decision 308, the workflow execution process 300 can obtain 310 any outputs from the next task. Thereafter, a decision 312 can determine whether the automation workflow process has any additional tasks that are to be performed.

When the decision 312 determines that there are more tasks to be performed, then the workflow execution process 300 can return to block 302 and subsequent blocks so that a next task within the automation workflow process can be carried out in a similar fashion. On the other hand, once the decision 312 determines that there are no additional tasks to be performed by the automation workflow process, the workflow execution process 300 can end.

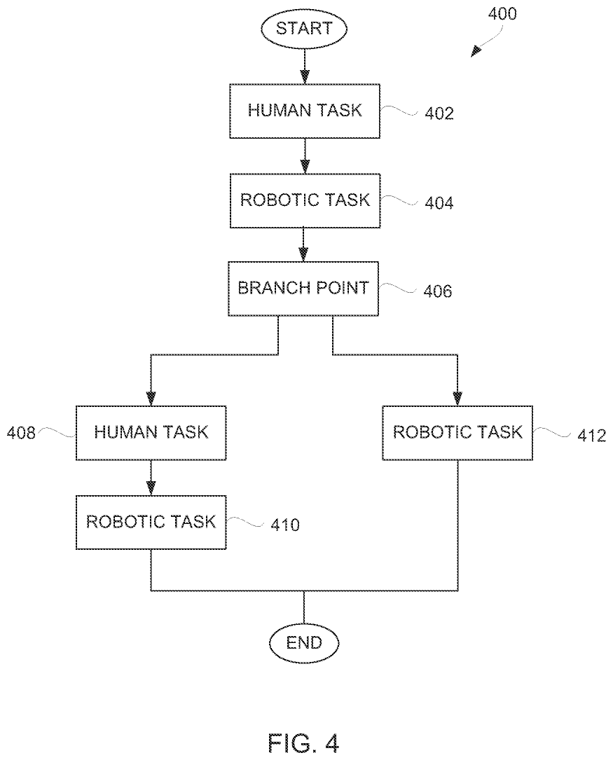

FIG. 4 is a flow diagram of a workflow coordination process 400 according to one embodiment. The workflow coordination process 400 illustrates that an automation workflow process can utilize a combination of human tasks along with robotic tasks to carry out an automation workflow process. The workflow coordination process 400 also indicates that conditional logic for branching can be included within an automation workflow process to support more sophisticated workflow processes.

The workflow coordination process 400 illustrated in FIG. 4 illustrates that the automation workflow process to be carried out can include a sequential arrangement of human tasks, robotic tasks, and/or branching points that together carry out the automation workflow process. In this embodiment, the workflow coordination process 400, once started, initiates a human task 402. Then, following the human task 402, a robotic task 404 can be performed.

After the robotic task 404, a branch point 406 in the workflow process 400 can be reached. The branch point 406 can utilize conditional logic to decide which of two or more processing branches are to be utilized. As illustrated in FIG. 4, following a first branch from the branch point 406, a human task 408 can be carried out and then a robotic task 410 can be carried out. Alternatively, in a second branch from the branch point 406, a robotic task 412 can be performed. Whether the first branch or the second branch is taken depends on conditional logic and evaluation of associated conditions. As an example, a workflow execution engine, can evaluate the conditional logic based on data provided by the previous processing of the workflow coordination process 400 (or data otherwise available thereto). Following the robotic task 410 or the robotic task 412, the workflow coordination process 400 can end.

It should be recognized that the workflow coordination process 400 is a simplified embodiment. In general, both human and robotic tasks can be ordered and arranged in many different sequences, and may also include one or more branching points. As such, the ordering of human and robotic tasks can be arranged in any sequence. Although the workflow coordination process 400 starts with the human task 402 followed by the robotic task 404, in alternative embodiment a workflow coordination process can start with a robotic task which can be followed by a human task or another robotic task.

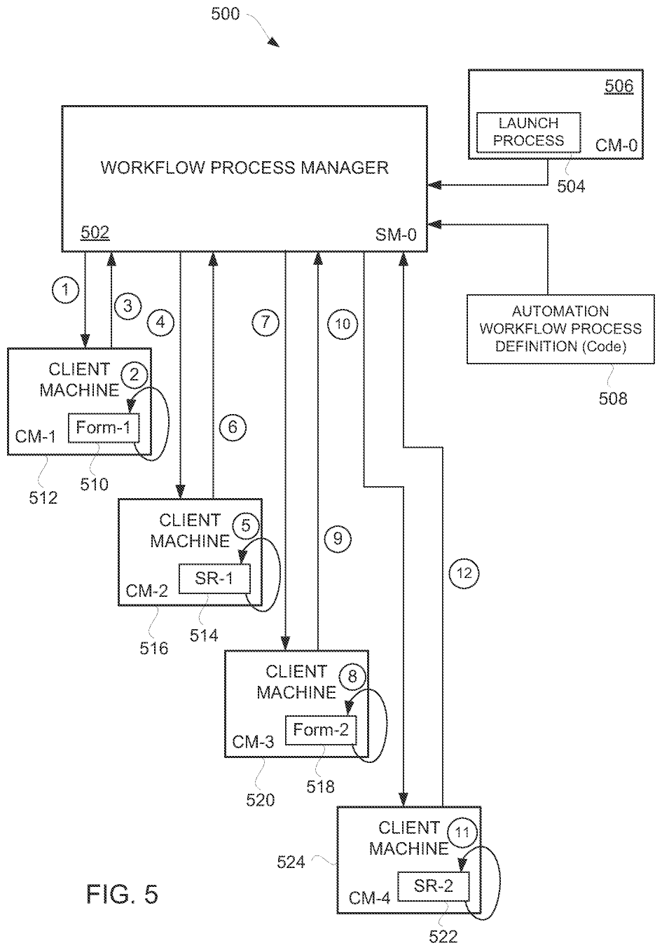

FIG. 5 illustrates a block diagram of an RPA system 500 according to one embodiment. The RPA system 500 includes a workflow process manager 502 that is capable of performing (e.g., launching) an automation workflow process 504. The workflow process manager 502 can, in one implementation, be included within the workflow process platform 104 illustrated in FIG. 1. The automation workflow process that is to be performed can be created by the workflow process platform 104 illustrated in FIG. 1 or the workflow process generator 202 illustrated in FIG. 2. In one implementation, the workflow process manager 502 operates on a server machine (SM-0), such as the RPA server 102 illustrated in FIG. 1.

To initiate the workflow process 504, a launch request can be received by the workflow process manager 502. The launch request can be initiated manually by a user or automatically by programmatic code. In one implementation, this launch request can be carried out on a client machine 506 (CM-0). The workflow process 504 to be carried out can be described by a workflow process definition 508. The workflow process definition 508 is typically either a computer readable structured description of the processing to be carried out or executable code derived therefrom. The particular workflow process definition 508 can be stored in a repository or data storage accessible to the workflow process manager 502. Alternatively, the particular workflow process definition 508 can be stored in the client machine 506 (CM-0).

The workflow process manager 502 carries out the workflow process 504. In doing so, the workflow process manager 502 can interact with various different computing devices where robotic agents and/or users or teams of users can participate in performing portions of the workflow process 504.

More particularly, in one embodiment, the workflow process manager 502 can initially present a form 510 (Form-1) to a user at a first client machine 512 (CM-1). Then, the user of the first client machine 512 can interact with the form 510 to provide requested input data. After the requested input data has been submitted back to the workflow process manager 502, the workflow process manager 502 can determine a next task to be performed. In this embodiment, the next task is for the workflow process manager 502 to cause a first software robot 514 (SR-1) to be carried out (i.e., launched) on a second client machine 516 (CM-2). The first robotic agent 514 can then operate on the second client machine 516. Once the first robotic agent 514 completes, any outputs can be returned to the workflow process manager 502.

Thereafter, the workflow process manager 502 can determine a next task to be performed. In this embodiment, the next task is to present a form 518 (Form-2) to a user of a third client machine 520 (CM-3). The user at the third client machine 520 can then interact with the form 518 to provide input data. After the user submits the form 518, the input data can be provided to the workflow process manager 502. The workflow process manager 502 can then determine a next task to be performed. In this embodiment, the next task is for the workflow process manager 502 to cause a second software robot 522 (SR-2) to be carried out on a fourth client machine 524 (CM-4). When the second robotic agent 522 completes its processing, any outputs can be returned back to the workflow process manager 502. Thereafter, if there are no additional tasks to be carried out according to the workflow process 504 being performed, then the workflow process manager 502 notes that the workflow process 504 has been completed.

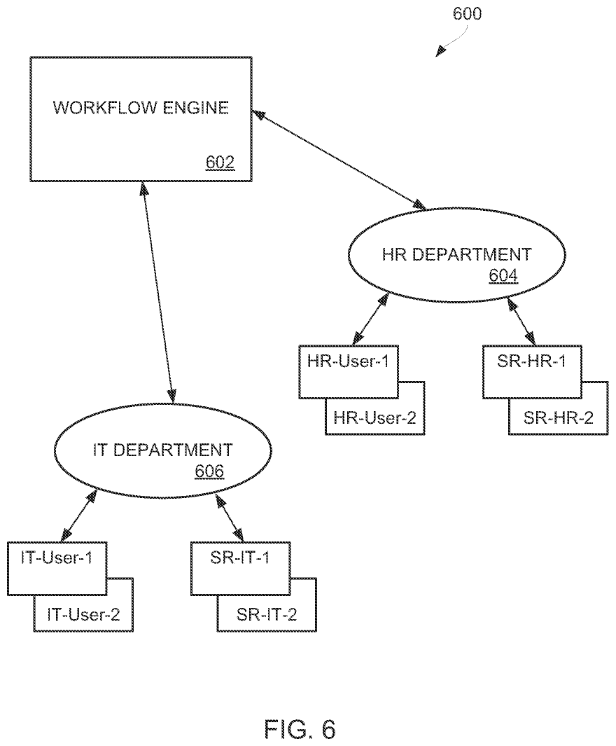

FIG. 6 is a block diagram of a distributed workflow process 600 according to one embodiment. The distributed workflow process 600 includes a workflow engine 602 that interacts with a Human Resources (HR) department 604 as well as with an Information Technology (IT) department 606. The workflow engine 602 can carry out a particular automation workflow process. In doing so, some interactions requested by the automation workflow process would be directed to the HR department 604 and other actions would be directed to the IT department 606. The sequencing of the automation workflow process and the decision to utilize resources (e.g., humans or computing devices or software robots) at either the HR department 604 or the IT department 606 would be controlled and detailed by the particular automation workflow process.

The HR department 604 can be associated with a team of users to the HR department 604. For example, as illustrated in FIG. 6, the team associated with the HR department 604 can include two distinct users, denoted as HR-user-1 and HR-user-2. These users are available within the HR department 604 to complete form tasks in an automation workflow process. For example, a form task can seek input from one of the users within the team associated with the HR department. Additionally, the HR department 604 can include a pool of programming resources, such as software robots that can be performed on computing devices associated with or authorized for use by the HR department 604. As illustrated in FIG. 6, the pool of programming resources available to the HR department 604 can include a first software robot and a second software robot, denoted SR-HR-1 and SR-HR-2, respectively.

The IT department 606 can similarly be associated with a team of users to the IT department 606. For example, as illustrated in FIG. 6, the team associated with the IT department 606 can include two distinct users, denoted as IT-user-1 and IT-user-2. These users are available within the IT department 606 to complete form tasks in an automation workflow process. For example, a form task can seek input from one of the users within the team associated with the IT department. Additionally, the IT department 604 can include a pool of programming resources, such as software robots that can be performed on computing devices associated with or authorized for use by the IT department 606. As illustrated in FIG. 6, the pool of programming resources available to the IT department 606 can include a first robotic software robot and a second software robot, denoted SR-IT-1 and SR-IT-2, respectively.

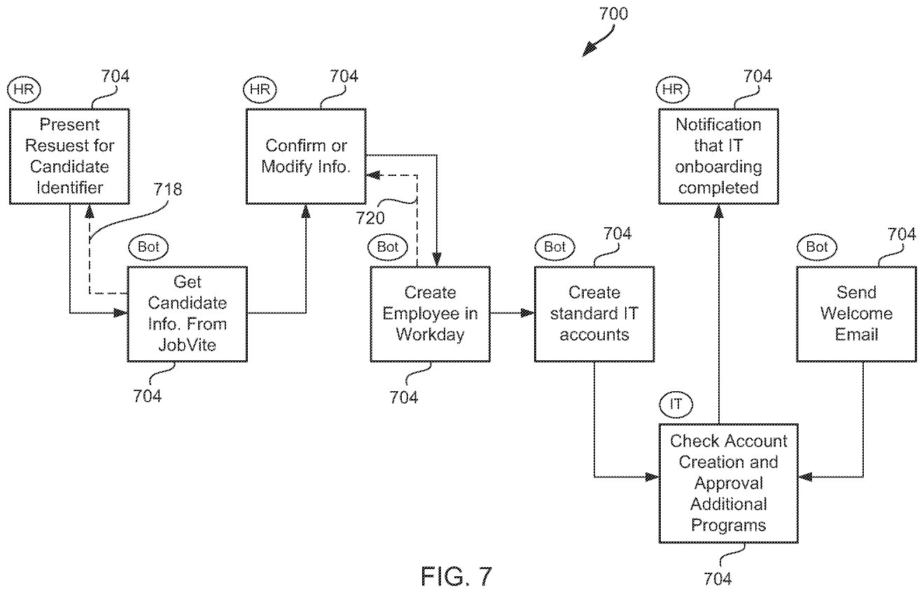

FIG. 7 is a block diagram of an employee onboarding workflow process 700 according to one embodiment. The employee onboarding workflow process 700 automates onboarding of a new employee across multiple departments of an organization. The onboarding workflow process 700 incorporates human tasks, robotic tasks, data exchange amongst tasks, and conditional logic. The onboarding workflow process 700 is an automation workflow process that can be carried out by a workflow process platform, such as the workflow process platform 104 illustrated in FIG. 1.

The onboarding workflow process 700 includes a workflow process description that describes the series of tasks associated with the process as well as inputs and outputs with respect to those tasks. The workflow process description can also include conditional logic to evaluate data received or produced by a task and or irregular events.

The onboarding workflow process 700 can begin with an initial task, namely, a first HR team task 702. The first HR team task 702 is a human task that is directed to a member of the HR team to provide a user input. In this case, the user input is for a candidate identifier for the new employee. In one implementation, the first HR team task 702 can present a form on a display device associated with a client computer of the member of the HR team. The member of the HR team can then interact with the form to input the candidate identifier of the new employee. The form being displayed can also include a submit button that allows the member of the HR team to submit the candidate identifier back to the workflow process platform. At this point, the first HR team task 702 is deemed completed.

Next, the onboarding workflow process 700 can be consulted to determine a next task to be performed. In the case of the onboarding workflow process 700, following the first HR team task 702, a first robotic task 704 is to be performed. The first robotic task 704 identifies a particular software robot, i.e., software processing agent, that is to be performed. The onboarding workflow process 700 can also specify inputs to the first robotic task 704 and/or outputs from the first robotic task 704. In this embodiment, the first robotic task 704 can operate to cause the particular software robot to automatically retrieve known candidate information from an employee tracking and recruiting software system, such as JobVite™. In such case, the retrieved candidate information can be provided to the workflow process platform.

Following the completion of the first robotic task 704, the next task to be carried out according to the employee onboarding workflow process 700 is a second HR team task 706. The second HR team task 706 is a human task that is directed to a member of the HR team to confirm or modify the candidate information that was retrieved by the first robotic task 704. In one implementation, the second HR team task 706 can present a data entry form on a display device associated with a client computer of the user of the HR team, where the data entry form is populated with the candidate information that was retrieved by the first robotic task 704. The member of the HR team can then view the candidate information that is populated within the data entry form to either confirm or modify such information. Once the member of the HR team has completed their review, the member can submit the data entry form as confirmed or modified back to the workflow process platform. At this point, the second HR team task 706 is deemed completed.

According to the on boarding workflow process 700, after completion of the second HR team task 706, a second robotic task 708 can be performed. The second robotic task 708 identifies a particular software robot, i.e., software processing agent, that is to be performed. The onboarding workflow process 700 can also specify inputs to the second robotic task 708 and/or outputs from the second robotic task 708. In this embodiment, the second robotic task 708 can operate to cause the particular software robot to automatically create one or more employee records in a payroll management system, such as Workday™. Once the employee records have been successfully established, the second robotic task 708 is deemed completed.

Thereafter, after completion of the second robotic task 708, a third robotic task 710 can be performed. The third robotic agent task 710 identifies a particular software robot, i.e., software processing agent, that is to be performed. The onboarding workflow process 700 can also specify inputs to the third robotic task 710 and/or outputs from the third robotic task 710. In one implementation, the third robotic task 710 can operate to cause the particular software robot to automatically create one or more computer accounts in an enterprise computer system for use by the new employee. Once the computer accounts have been successfully established, the third robotic task 710 is deemed completed. Note that, while the second robotic agent task 708 is likely performed on a computing device affiliated with the HR department, the third robotic task 710 is likely performed on a computing device affiliated with the IT department.

Next, according to the onboarding workflow process 700, the next task to be carried out by the employee onboarding workflow process is a first IT team task 712. The first IT team task 712 is a human task that is directed to a member of the IT team to confirm account creation as well as approve any special programs (or applications) that are to be provided to the new employee. In one implementation, the first IT team task 712 can present a form on a display device associated with a client computer of a member of the IT team. The member of the IT team can then review account creation information that is presented in the form, and can also potentially interact with the form to designate or select any special applications/programs to be provided to the new employee. Once the member of the IT team has completed their review and provided any inputs (e.g., selections) with respect to the form, the member can submit the form to the workflow process platform. At this point, the first IT team task 712 is deemed completed.

Finally, according to the onboarding workflow process 700, following the first IT team task 712, two different tasks can be carried out. These two tasks include a third HR team task 714 and a fourth robotic task 716. These two tasks can be carried out in series or in parallel. The third HR team task 714 is a human task that is directed to the HR team home to notify them that the IT department has completed its IT related onboarding efforts for the new employee. The fourth robotic task 716 identifies a particular software robot, i.e., software processing agent, that is to be performed. The fourth robotic task 716 can operate to automatically send a welcome email to the new employee. After the completion of the fourth robotic task 716 and also the third HR team task 714, the employee onboarding workflow process 700 is completed.

The workflow process platform in carrying out the onboarding workflow process 700 (or any other workflow processes) can not only manage process flow and data flow between tasks, but also provide data storage (e.g., variable storage), fallback situations, error checking and exception handling. By embedding conditional logic in an automated workflow process, such as the employee onboarding workflow process 700, the workflow process platform is able to handle fallback situations, error checking and exception handling. As one example, the onboarding workflow process 700 can include a fallback situation 718, such as logic (e.g., conditional logic) to cause the process flow to return back to the first HR team task 702 if the first robotic task 704 determines that the candidate identifier provided by the first HR team task 702 is not recognized by the particular software robot used by the first robotic task 704. In such an example, the first HR team task 702 can require a HR team member to recheck and again enter a candidate identifier for the new employee.

As another example, the onboarding workflow process 700 can include an exception handling 720, such as logic (e.g., conditional logic) to cause the process flow to return back to the second HR team task 706 if the second robotic task 708 determines that the particular software robot used by the second robotic task 708 produced an exception during its operation. Using the logic embedded in the onboarding workflow process 700, process flow can return back to the second HR team task 706 where the exception can be recognized and handled with exception processing embedded in the onboarding workflow process 700.

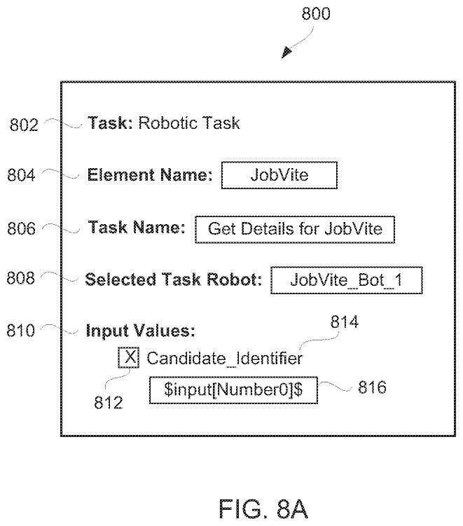

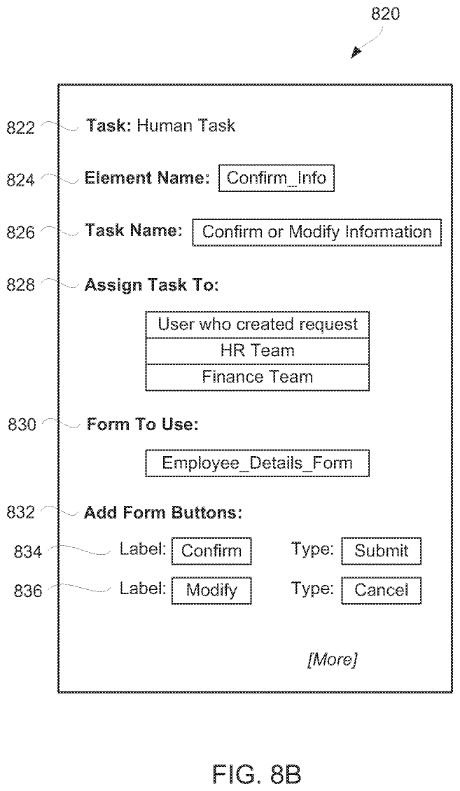

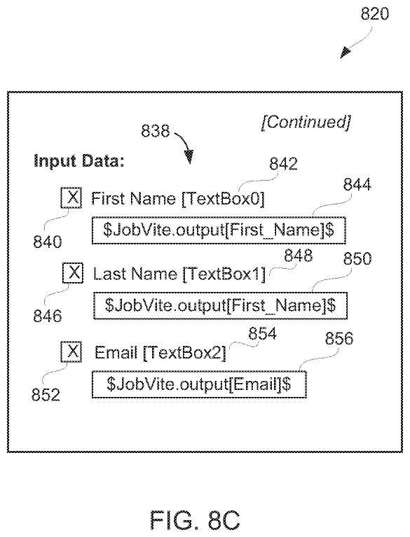

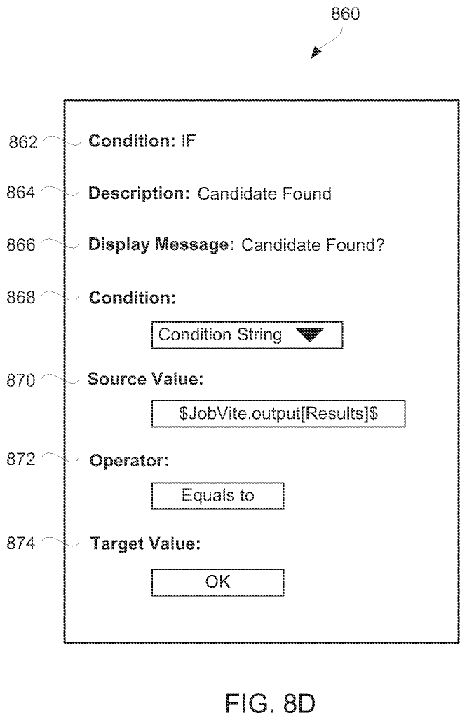

FIGS. 8A-8D are exemplary screenshots of configuration screens that can be used to configure operation of an automation workflow process, according to one embodiment.

FIG. 8A is a screenshot of a robotic task configuration screen 800 according to one embodiment. The robotic task configuration screen 800 is a screen that can be presented on a display screen associated with a computing device, namely, the computing device associated with a user that is creating an automation workflow process. The robotic task configuration screen 800 includes a task indicator 802, an element name 804, a task name 806, a selected task robot 808, and input values 810.

The task indicator 802, in this example, indicates that the involved task being configured is a robotic task, which is an automated task carried out by a software robot. The element name 804 provides a name for the task within an automated workflow process. In this example, the element name is “JobVite” which is a job-based service provider that is being utilized. The task name 806 provides a descriptive name for the task being carried out by the software robot. In this example, the task name 806 provided by a user interacting with the robotic task configuration screen 800 is “Get Details form JobVite”. The selected task robot 808 provides an identifier for the particular software robot that is to be utilized when the robotic task is initiated. In this example, the selected task robot 808 is identified as “JobVite_Bot_1”. The input values 810 being identified in robotic task configuration screen 800 vary depending upon the type of software robot and its operations. In this particular example, one input for the robotic task is a possible input and selectable by a checkbox 812. If the checkbox 812 is “checked,” then the Candidate_Identifier 814, which is the input sought by the software robot, can be specified. To do so, the robotic task configuration screen 800 can include a text box 816 where a variable name can be specified for use with the software robot as the Candidate_Identifier 814. As an example, a prior human task could have been performed to obtain, from a user, a candidate identifier to be processed. Since the obtained candidate identifier is represented as a variable, the variable can be specified in text box 816. In this example, the variable name placed in the text box 816 is “$input[Number0]$”, which links the output of the prior human task to the input of the subsequent robotic task. As such, in general, any output value from a prior task of an automation workflow process is able to be specified and utilized in a subsequent task.

FIGS. 8B and 8C are screenshots of a human task configuration screen 820 according to one embodiment. FIG. 8B depicts the first part of the human task configuration screen 820 and FIG. 8C depicts the second part of the human task configuration screen. The human task configuration screen 820 is, for example, a graphical user interface that is presented on a display screen so that a user can configure the associated human task. In this example, the human task when executed presents a graphical user interface on a display screen so that a member of a team of an organization, such as an HR team, can confirm employee data being presented by the graphical user interface.

As shown in FIG. 8B, the human task configuration screen 820 includes a task identifier 822 and element name 824, a task name 826, an assignment request 828, and a form identifier 830. The task identifier 822 notes that the involved task is a human task to be carried out by a person. The element name 824 specifies the name of the element for the task within the automation workflow process. In this example, the element name 824 is denoted “Confirm Info”. The task name 826 provides a descriptive name for the task that can be displayed, which in this case is “Confirm or Modify Information”. The assignment request 828 permits the process workflow platform to assign the involved human task to an individual or group. For example, the task can is be assigned to a user who initially created the request, or to a member of a team (e.g., HR team or IT team). The assignment request 828 may, in one embodiment, be presented in list form for a user to select or, in another embodiment, may be manually entered by the user. The form identifier 830 can be used to specify a form name that is to be utilized by the human task. In this example, the form name is “Employee_Details_Form”. In this example, the identified form is an electronic form that is presented as or within a graphical user interface to the assigned individual or group when this human task is performed.

The human task configuration screen 820 also includes a button option 832 to add on or more buttons (i.e., user controls) to the form. In this example, two buttons have been added to the form. A first button 834 is labeled “Confirm” and has a type “Submit”, and a second button has a label “Modify” and has a type “Cancel”. These buttons 834 and 836 can be added to the existing form such that the user can inform the process workflow platform as to whether the employee information has been confirmed or whether it should be modified.

As shown in FIG. 8C, the human task configuration screen 820 can also specify input data 838 to be utilized with the associated form of the human task. In this example, the input data 838 for the form can optionally include first name, last name and email for the employee. The human task configuration screen 820 includes a selector 840, a first name designator 842, and a variable name 844 that is to correspond to the first name designator. In this example, the variable name 844 is specifying an output variable pertaining to a first name from the earlier robotic task that interacts with the JobVite service provider. The human task configuration screen 820 also includes a selector 846, a last name designator 848, and a variable name 850 that is to correspond to the last name designator. In this example, the variable name 850 is specifying an output variable pertaining to a last name from the earlier robotic task that interacts with the JobVite service provider. The human task configuration screen 820 also includes a selector 852, an email designator 854, and a variable name 856 that is to correspond to the email designator. In this example, the variable name 856 is specifying an output variable pertaining to an email address from the earlier robotic task that interacts with the JobVite service provider. Hence, the human task, when performed, can present in a user interface (e.g., electronic form) one or more variables (e.g., text strings) that were obtained and output from the earlier robotic task.

FIG. 8D is a screenshot of a condition configuration screen 860 according to one embodiment. The condition configuration screen 860 can be utilized to enable a user to specify conditional logic for an automation workflow process. The conditional logic being specified can also be referred to as a conditional task. The conditional logic can be used to provide conditional branching in processing flow of an automation workflow process. In general, the conditional logic can be based on a condition such as if-than-else which be performed with strings, numbers, or Boolean inputs.

The condition configuration screen 860 includes a condition identifier 862, a description identifier 864, and a display message 866. The condition identifier 862, in this example, specifies that the conditional logic is a “IF” condition. The description identifier 864 indicates that a description for the conditional logic can be “Candidate Found”. The display message 866 can specify a message during performance of the condition task. In this example, the display message 866 is “Candidate Found?”.

Still further, the condition configuration screen 860 can provide a condition indicator 868, a source value 870, a logical operator 872, and a target value 874. In this example, the condition indicator 868 is indicating that the conditioned is premised on a string value. The source value 870 can specify what value is being conditionally checked. In this example, the source value being checked is an output result from a software robot. Specifically, the output of the JobVite robotic task (which would be a prior task) is used as a source input value for the conditional logic of the automation workflow process. Hence, the source value 870 can specify a variable as output from the JobVite robotic task. The operator indicator 872 specifies the logical operation to be utilized. In this example, the logical operator is “Equals to” but various other logical operators can be used (e.g., less than, greater than, less than or equal to, greater than or equal to). Finally, the target value 874 specifies the value to which the logical operation is to be compared. In this example, the target value 874 is “OK”. Hence, if the variable output from the JobVite robotic task is equal to the target value “OK”, then during performance of the IF condition associated with the conditional logic (i.e., condition task within the automation workflow process) the automation workflow process would proceed to perform tasks in the associated branch.

As noted above, conditional logic can be used to provide conditional branching in processing flow of an automation workflow process. In one embodiment, the workflow process platform can use ternary logic operations. Here, in evaluating logical conditions, processes may result in a true, false or missing. A result is “missing” when a condition cannot be fully evaluated because some input is missing. For example, need data may be unavailable because the workflow executed in a different branch so the data is missing; some error occurred in a task so the data was not received; or due to changes to task designs that result in error (e.g., variable reference is invalid). To provide a more robust operation of the workflow process platform, an automation workflow process can handle the missing data gracefully such that the automation workflow process can normally continue. A missing data item can be handled using ternary logic. For example, for a condition:

result_from_step1==4)∥(result_from_step2==result_from_step3)

If result_from_step1 is missing, then the whole (result_from_step1==4) is considered missing, and equivalently if result_from_step2 or result_from_step3 is missing, then the whole (result_from_step2==result_from_step3) is considered missing. Each part of the conditional produces a ternary result, and then the parts are combined using the logic tables below to produce the final result. If the statement produces a true value, then the commands within the condition will be executed; if the statement produces a missing or false value, the interpreter moves to the next else-if and evaluates that condition. If all of the else-if's fail, then eventually the else will execute.

Logic tables for ternary logic (i.e., three valued logic) are below, and can be used when combining sequences of logical statements.

Ternary-AND (&&) Table

| | TRUE | FALSE | MISSING |
|---|---|---|---|
| TRUE | TRUE | FALSE | MISSING |
| FALSE | FALSE | FALSE | MISSING |
| MISSING | MISSING | MISSING | MISSING |

Ternary-OR (||) Table

| | TRUE | FALSE | MISSING |
|---|---|---|---|
| TRUE | TRUE | TRUE | TRUE |
| FALSE | TRUE | FALSE | FALSE |
| MISSING | TRUE | FALSE | MISSING |

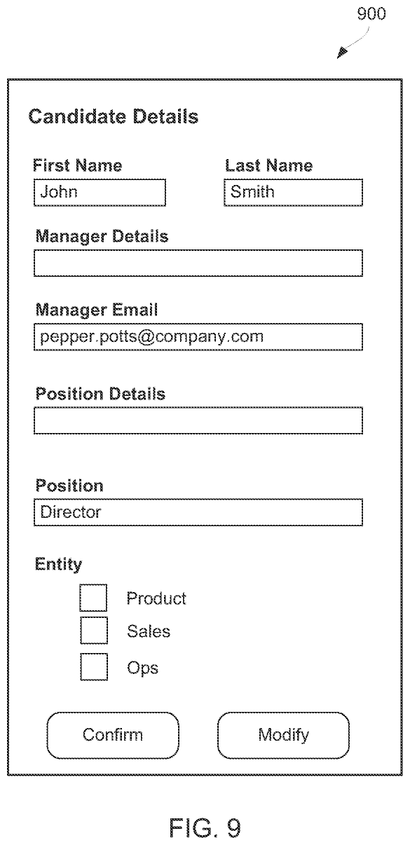

FIG. 9 is s screenshot of an exemplary form 900 that can be present to a person in content of a human task, according to one embodiment. In this form 900, candidate information can be presented to a HR team member, whom can the confirm or modify the presented information. This form 900 is, for example, suitable for use as the form presented by the second HR team task 706 of the onboarding workflow process 700 illustrated in FIG. 7.

In an automated workflow process, such the onboarding workflow process 700 illustrated in FIG. 7, an example of a definition (i.e., description) that can be produced by the workflow process flatform, according to one exemplary embodiment, is as contained in Appendix A, which is included or incorporated herein into this document. Notable, in this exemplary embodiment, the automated workflow process for employee onboarding is described in a computer-readable manner, such that the process can be implemented by a computing device supporting the workflow process platform.

The various aspects disclosed herein can be utilized with or by robotic process automation systems. Exemplary robotic process automation systems and operations thereof are detailed below.

The various aspects disclosed herein can be utilized with or by robotic process automation systems. Exemplary robotic process automation systems and operations thereof are detailed below.

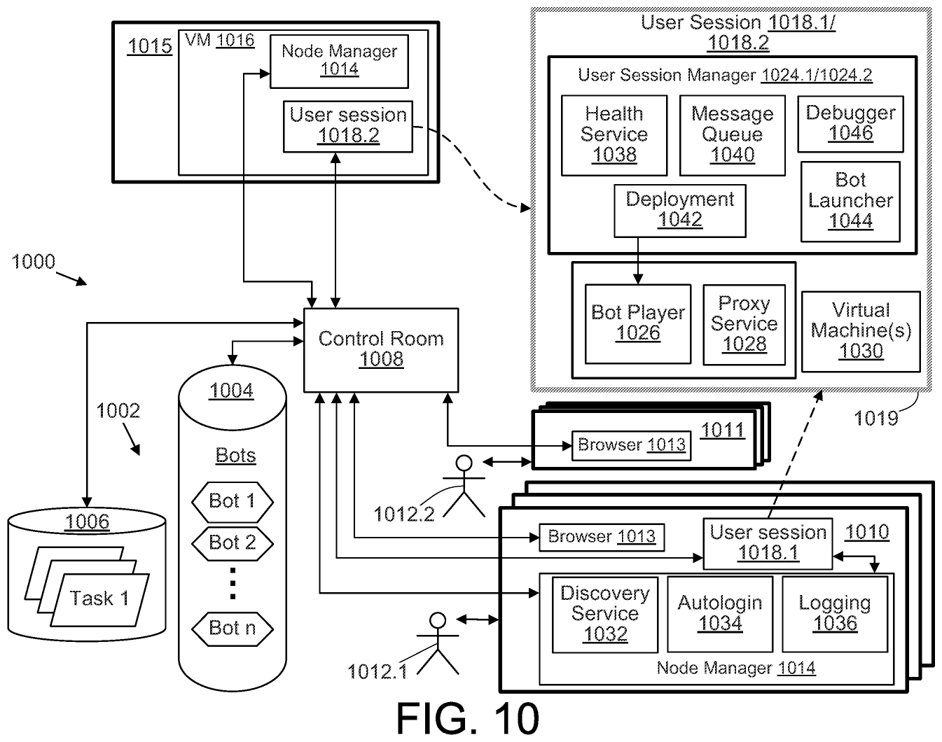

FIG. 10 is a block diagram of a robotic process automation (RPA) system 1000 according to one embodiment. The RPA system 1000 includes data storage 1002. The data storage 1002 can store a plurality of software robots 1004, also referred to as bots (e.g., Bot 1, Bot 2, . . . , Bot n, where n is an integer). The software robots 1004 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 1026), on which a bot will execute or is executing. The data storage 1002 can also stores a plurality of work items 1006. Each work item 1006 can pertain to processing executed by one or more of the software robots 1004.

The RPA system 1000 can also include a control room 1008. The control room 1008 is operatively coupled to the data storage 1002 and is configured to execute instructions that, when executed, cause the RPA system 1000 to respond to a request from a client device 1010 that is issued by a user 1012.1. The control room 1008 can act as a server to provide to the client device 1010 the capability to perform an automation task to process a work item from the plurality of work items 1006. The RPA system 1000 is able to support multiple client devices 1010 concurrently, each of which will have one or more corresponding user session(s) 1018, which provides a context. The context can, for example, include security, permissions, audit trails, etc. to define the permissions and roles for bots operating under the user session 1018. For example, a bot executing under a user session, cannot access any files or use any applications that the user, under whose credentials the bot is operating, does not have permission to do so. This prevents any inadvertent or malicious acts from a bot under which bot 1004 executes.

The control room 1008 can provide, to the client device 1010, software code to implement a node manager 1014. The node manager 1014 executes on the client device 1010 and provides a user 1012 a visual interface via browser 1013 to view progress of and to control execution of automation tasks. It should be noted that the node manager 1014 can be provided to the client device 1010 on demand, when required by the client device 1010, to execute a desired automation task. In one embodiment, the node manager 1014 may remain on the client device 1010 after completion of the requested automation task to avoid the need to download it again. In another embodiment, the node manager 1014 may be deleted from the client device 1010 after completion of the requested automation task. The node manager 1014 can also maintain a connection to the control room 1008 to inform the control room 1008 that device 1010 is available for service by the control room 1008, irrespective of whether a live user session 1018 exists. When executing a bot 1004, the node manager 1014 can impersonate the user 1012 by employing credentials associated with the user 1012.

The control room 1008 initiates, on the client device 1010, a user session 1018 (seen as a specific instantiation 1018.1) to perform the automation task. The control room 1008 retrieves the set of task processing instructions 1004 that correspond to the work item 1006. The task processing instructions 1004 that correspond to the work item 1006 can execute under control of the user session 1018.1, on the client device 1010. The node manager 1014 can provide update data indicative of status of processing of the work item to the control room 1008. The control room 1008 can terminate the user session 1018.1 upon completion of processing of the work item 1006. The user session 1018.1 is shown in further detail at 1019, where an instance 1024.1 of user session manager 1024 is seen along with a bot player 1026, proxy service 1028, and one or more virtual machine(s) 1030, such as a virtual machine that runs Java® or Python®. The user session manager 1024 provides a generic user session context within which a bot 1004 executes.

The bots 1004 execute on a bot player, via a computing device, to perform the functions encoded by the bot. Some or all of the bots 1004 may, in certain embodiments, be located remotely from the control room 1008. Moreover, the devices 1010 and 1011, which may be conventional computing devices, such as for example, personal computers, server computers, laptops, tablets and other portable computing devices, may also be located remotely from the control room 1008. The devices 1010 and 1011 may also take the form of virtual computing devices. The bots 1004 and the work items 1006 are shown in separate containers for purposes of illustration but they may be stored in separate or the same device(s), or across multiple devices. The control room 1008 can perform user management functions, source control of the bots 1004, along with providing a dashboard that provides analytics and results of the bots 1004, performs license management of software required by the bots 1004 and manages overall execution and management of scripts, clients, roles, credentials, security, etc. The major functions performed by the control room 1008 can include: (i) a dashboard that provides a summary of registered/active users, tasks status, repository details, number of clients connected, number of scripts passed or failed recently, tasks that are scheduled to be executed and those that are in progress, and any other desired information; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail-logs creation of all actions performed in the control room; (vi) task scheduler—permits scheduling tasks which need to be executed on different clients at any particular time; (vii) credential management—permits password management; and (viii) security: management—permits rights management for all user roles. The control room 1008 is shown + generally for simplicity of explanation. Multiple instances of the control room 1008 may be employed where large numbers of bots are deployed to provide for scalability of the RPA system 1000.

In the event that a device, such as device 1011 (e.g., operated by user 1012.2) does not satisfy the minimum processing capability to run a node manager 1014, the control room 1008 can make use of another device, such as device 1015, that has the requisite capability. In such case, a node manager 1014 within a Virtual Machine (VM), seen as VM 1016, can be resident on the device 1015. The node manager 1014 operating on the device 1015 can communicate with browser 1013 on device 1011. This approach permits RPA system 1000 to operate with devices that may have lower processing capability, such as older laptops, desktops, and portable/mobile devices such as tablets and mobile phones. In certain embodiments the browser 1013 may take the form of a mobile application stored on the device 1011. The control room 1008 can establish a user session 1018.2 for the user 1012.2 while interacting with the control room 1008 and the corresponding user session 1018.2 operates as described above for user session 1018.1 with user session manager 1024 operating on device 1010 as discussed above.

In certain embodiments, the user session manager 1024 provides five functions. First is a health service 1038 that maintains and provides a detailed logging of bot execution including monitoring memory and CPU usage by the bot and other parameters such as number of file handles employed. The bots 1004 can employ the health service 1038 as a resource to pass logging information to the control room 1008. Execution of the bot is separately monitored by the user session manager 1024 to track memory, CPU, and other system information. The second function provided by the user session manager 1024 is a message queue 1040 for exchange of data between bots executed within the same user session 1018. The third function is a deployment service (also referred to as a deployment module) 1042 that connects to the control room 1008 to request execution of a requested bot 1004. The deployment service 1042 can also ensure that the environment is ready for bot execution, such as by making available dependent libraries. The fourth function is a bot launcher 1044 which can read metadata associated with a requested bot 1004 and launch an appropriate container and begin execution of the requested bot. The fifth function is a debugger service 1046 that can be used to debug bot code.

The bot player 1026 can execute, or play back, a sequence of instructions encoded in a bot. The sequence of instructions can, for example, be captured by way of a recorder when a human performs those actions, or alternatively the instructions are explicitly coded into the bot. These instructions enable the bot player 1026, to perform the same actions as a human would do in their absence. In one implementation, the instructions can compose of a command (or action) followed by set of parameters. For example, Open Browser is a command and a URL would be the parameter for it to launch a web resource. Proxy service 1028 can enable integration of external software or applications with the bot to provide specialized services. For example, an externally hosted artificial intelligence system can enable the bot to understand the meaning of a “sentence.”

The user 1012.1 can interact with node manager 1014 via a conventional browser 1013 which employs the node manager 1014 to communicate with the control room 1008. When the user 1012.1 logs in from the client device 1010 to the control room 1008 for the first time, the user 1012.1 can be prompted to download and install the node manager 1014 on the device 1010, if one is not already present. The node manager 1014 can establish a web socket connection to the user session manager 1024, deployed by the control room 1008 that lets the user 1012.1 subsequently create, edit, and deploy the bots 1004.

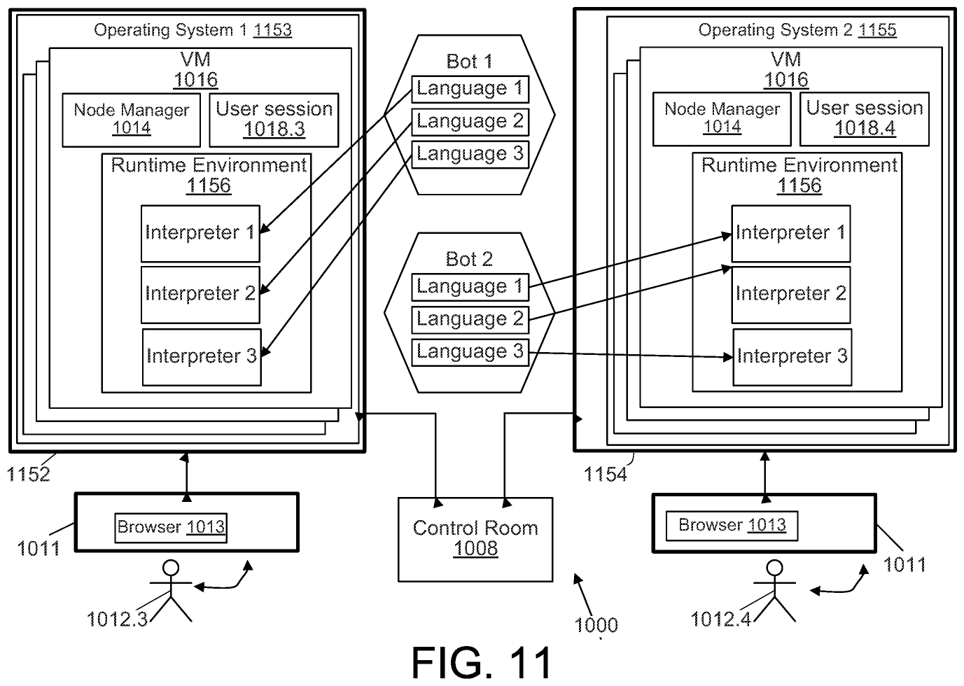

FIG. 11 is a block diagram of a generalized runtime environment for bots 1004 in accordance with another embodiment of the RPA system 1000 illustrated in FIG. 10. This flexible runtime environment advantageously permits extensibility of the platform to enable use of various languages in encoding bots. In the embodiment of FIG. 11, RPA system 1000 generally operates in the manner described in connection with FIG. 10, except that in the embodiment of FIG. 11, some or all of the user sessions 1018 execute within a virtual machine 1016. This permits the bots 1004 to operate on an RPA system 1000 that runs on an operating system different from an operating system on which a bot 1004 may have been developed. For example, if a bot 1004 is developed on the Windows® operating system, the platform agnostic embodiment shown in FIG. 11 permits the bot 1004 to be executed on a device 1152 or 1154 executing an operating system 1153 or 1155 different than Windows®, such as, for example, Linux. In one embodiment, the VM 1016 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 11, multiple devices 1152 can execute operating system 1, 1153, which may, for example, be a Windows® operating system. Multiple devices 1154 can execute operating system 2, 1155, which may, for example, be a Linux® operating system. For simplicity of explanation, two different operating systems are shown, by way of example and additional operating systems such as the macOS®, or other operating systems may also be employed on devices 1152, 1154 or other devices. Each device 1152, 1154 has installed therein one or more VM's 1016, each of which can execute its own operating system (not shown), which may be the same or different than the host operating system 1153/1155. Each VM 1016 has installed, either in advance, or on demand from control room 1008, a node manager 1014. The embodiment illustrated in FIG. 11 differs from the embodiment shown in FIG. 10 in that the devices 1152 and 1154 have installed thereon one or more VMs 1016 as described above, with each VM 1016 having an operating system installed that may or may not be compatible with an operating system required by an automation task. Moreover, each VM has installed thereon a runtime environment 1156, each of which has installed thereon one or more interpreters (shown as interpreter 1, interpreter 2, interpreter 3). Three interpreters are shown by way of example but any run time environment 1156 may, at any given time, have installed thereupon less than or more than three different interpreters. Each interpreter 1156 is specifically encoded to interpret instructions encoded in a particular programming language. For example, interpreter 1 may be encoded to interpret software programs encoded in the Java® programming language, seen in FIG. 11 as language 1 in Bot 1 and Bot 2. Interpreter 2 may be encoded to interpret software programs encoded in the Python® programming language, seen in FIG. 11 as language 2 in Bot 1 and Bot 2, and interpreter 3 may be encoded to interpret software programs encoded in the R programming language, seen in FIG. 11 as language 3 in Bot 1 and Bot 2.

Turning to the bots Bot 1 and Bot 2, each bot may contain instructions encoded in one or more programming languages. In the example shown in FIG. 11, each bot can contain instructions in three different programming languages, for example, Java®, Python® and R. This is for purposes of explanation and the embodiment of FIG. 11 may be able to create and execute bots encoded in more or less than three programming languages. The VMs 1016 and the runtime environments 1156 permit execution of bots encoded in multiple languages, thereby permitting greater flexibility in encoding bots. Moreover, the VMs 1016 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 1008 will select a device with a VM 1016 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

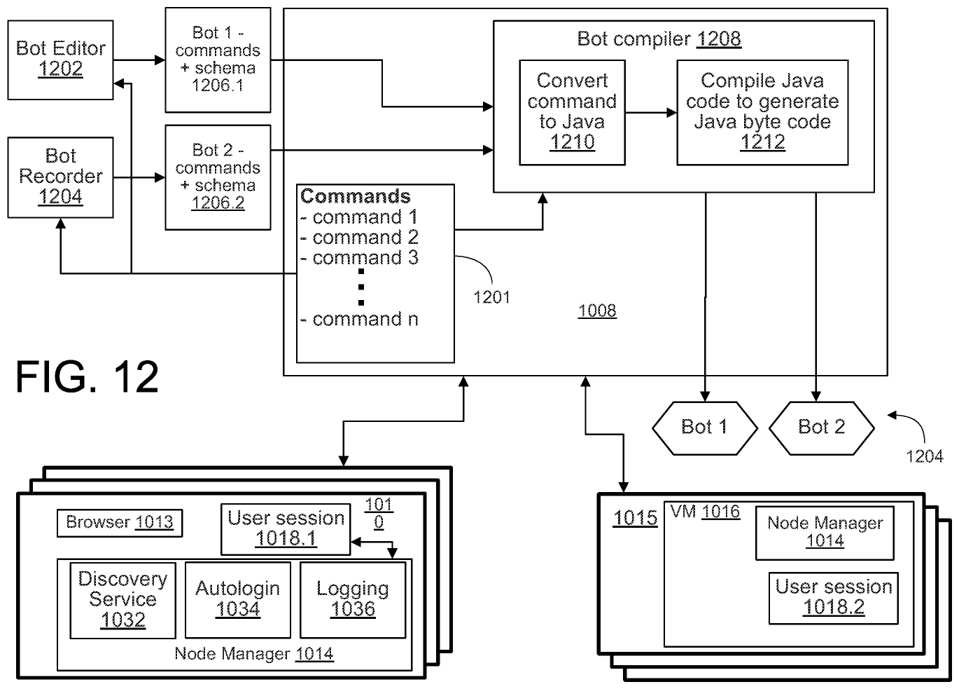

FIG. 12 illustrates a block diagram of yet another embodiment of the RPA system 1000 of FIG. 10 configured to provide platform independent sets of task processing instructions for bots 1004. Two bots 1004, bot 1 and bot 2 are shown in FIG. 12. Each of bots 1 and 2 are formed from one or more commands 1201, each of which specifies a user level operation with a specified application program, or a user level operation provided by an operating system. Sets of commands 1206.1 and 1206.2 may be generated by bot editor 1202 and bot recorder 1204, respectively, to define sequences of application-level operations that are normally performed by a human user. The bot editor 1202 may be configured to combine sequences of commands 1201 via an editor. The bot recorder 1204 may be configured to record application-level operations performed by a user and to convert the operations performed by the user to commands 1201. The sets of commands 1206.1 and 1206.2 generated by the editor 1202 and the recorder 1204 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 1008 operates to compile, via compiler 1208, the sets of commands generated by the editor 1202 or the recorder 1204 into platform independent executables, each of which is also referred to herein as a bot JAR (Java ARchive) that perform application-level operations captured by the bot editor 1202 and the bot recorder 1204. In the embodiment illustrated in FIG. 12, the set of commands 1206, representing a bot file, can be captured in a JSON (JavaScript Object Notation) format which is a lightweight data-interchange text-based format. JSON is based on a subset of the JavaScript Programming Language Standard ECMA-262 3rd Edition—December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 1010 and/or 1015 to perform the encoded application-level operations that are normally performed by a human user.

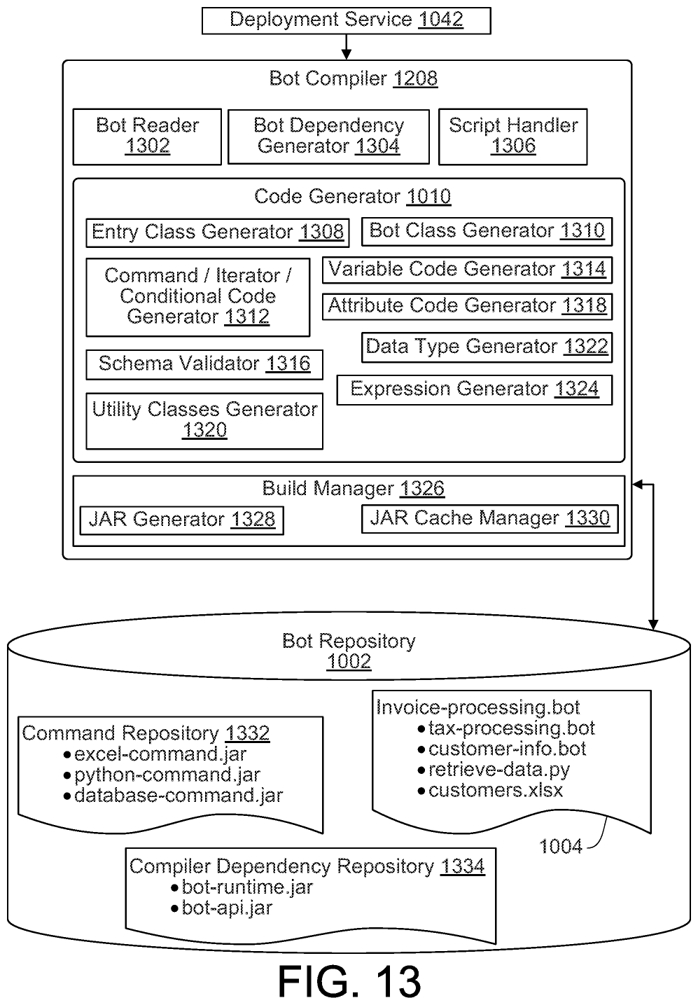

FIG. 13 is a block diagram illustrating details of one embodiment of the bot compiler 1208 illustrated in FIG. 12. The bot compiler 1208 accesses one or more of the bots 1004 from the data storage 1002, which can serve as bot repository, along with commands 1201 that are contained in a command repository 1332. The bot compiler 1008 can also access compiler dependency repository 1334. The bot compiler 1008 can operate to convert each command 1201 via code generator module 1210 to an operating system independent format, such as a Java command. The bot compiler 1008 then compiles each operating system independent format command into byte code, such as Java byte code, to create a bot JAR. The convert command to Java module 1210 is shown in further detail in in FIG. 13 by JAR generator 1328 of a build manager 1326. The compiling to generate Java byte code module 1212 can be provided by the JAR generator 1328. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 12, deployment service 1042 can be responsible to trigger the process of bot compilation and then once a bot has compiled successfully, to execute the resulting bot JAR on selected devices 1010 and/or 1015. The bot compiler 1208 can comprises a number of functional modules that, when combined, generate a bot 1004 in a JAR format. A bot reader 1302 loads a bot file into memory with class representation. The bot reader 1302 takes as input a bot file and generates an in-memory bot structure. A bot dependency generator 1304 identifies and creates a dependency graph for a given bot. It includes any child bot, resource file like script, and document or image used while creating a bot. The bot dependency generator 1304 takes, as input, the output of the bot reader 1302 and provides, as output, a list of direct and transitive bot dependencies. A script handler 1306 handles script execution by injecting a contract into a user script file. The script handler 1306 registers an external script in manifest and bundles the script as a resource in an output JAR. The script handler 1306 takes, as input, the output of the bot reader 1302 and provides, as output, a list of function pointers to execute different types of identified scripts like Python, Java, VB scripts.

An entry class generator 1308 can create a Java class with an entry method, to permit bot execution to be started from that point. For example, the entry class generator 1308 takes, as an input, a parent bot name, such “Invoice-processing.bot” and generates a Java class having a contract method with a predefined signature. A bot class generator 1310 can generate a bot class and orders command code in sequence of execution. The bot class generator 1310 can take, as input, an in-memory bot structure and generates, as output, a Java class in a predefined structure. A Command/Iterator/Conditional Code Generator 1312 wires up a command class with singleton object creation, manages nested command linking, iterator (loop) generation, and conditional (If/Else If/Else) construct generation. The Command/Iterator/Conditional Code Generator 1312 can take, as input, an in-memory bot structure in JSON format and generates Java code within the bot class. A variable code generator 1314 generates code for user defined variables in the bot, maps bot level data types to Java language compatible types, and assigns initial values provided by user. The variable code generator 1314 takes, as input, an in-memory bot structure and generates Java code within the bot class. A schema validator 1316 can validate user inputs based on command schema and includes syntax and semantic checks on user provided values. The schema validator 1316 can take, as input, an in-memory bot structure and generates validation errors that it detects. The attribute code generator 1318 can generate attribute code, handles the nested nature of attributes, and transforms bot value types to Java language compatible types. The attribute code generator 1318 takes, as input, an in-memory bot structure and generates Java code within the bot class. A utility classes generator 1320 can generate utility classes which are used by an entry class or bot class methods. The utility classes generator 1320 can generate, as output, Java classes. A data type generator 1322 can generate value types useful at runtime. The data type generator 1322 can generate, as output, Java classes. An expression generator 1324 can evaluate user inputs and generates compatible Java code, identifies complex variable mixed user inputs, inject variable values, and transform mathematical expressions. The expression generator 1324 can take, as input, user defined values and generates, as output, Java compatible expressions.

The JAR generator 1328 can compile Java source files, produces byte code and packs everything in a single JAR, including other child bots and file dependencies. The JAR generator 1328 can take, as input, generated Java files, resource files used during the bot creation, bot compiler dependencies, and command packages, and then can generate a JAR artifact as an output. The JAR cache manager 1330 can put a bot JAR in cache repository so that recompilation can be avoided if the bot has not been modified since the last cache entry. The JAR cache manager 1330 can take, as input, a bot JAR.

In one or more embodiment described herein command action logic can be implemented by commands 1201 available at the control room 1008. This permits the execution environment on a device 1010 and/or 1015, such as exists in a user session 1018, to be agnostic to changes in the command action logic implemented by a bot 1004. In other words, the manner in which a command implemented by a bot 1004 operates need not be visible to the execution environment in which a bot 1004 operates. The execution environment is able to be independent of the command action logic of any commands implemented by bots 1004. The result is that changes in any commands 1201 supported by the RPA system 1000, or addition of new commands 1201 to the RPA system 1000, do not require an update of the execution environment on devices 1010, 1015. This avoids what can be a time and resource intensive process in which addition of a new command 1201 or change to any command 1201 requires an update to the execution environment to each device 1010, 1015 employed in an RPA system. Take, for example, a bot that employs a command 1201 that logs into an on-online service. The command 1201 upon execution takes a Uniform Resource Locator (URL), opens (or selects) a browser, retrieves credentials corresponding to a user on behalf of whom the bot is logging in as, and enters the user credentials (e.g., username and password) as specified. If the command 1201 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

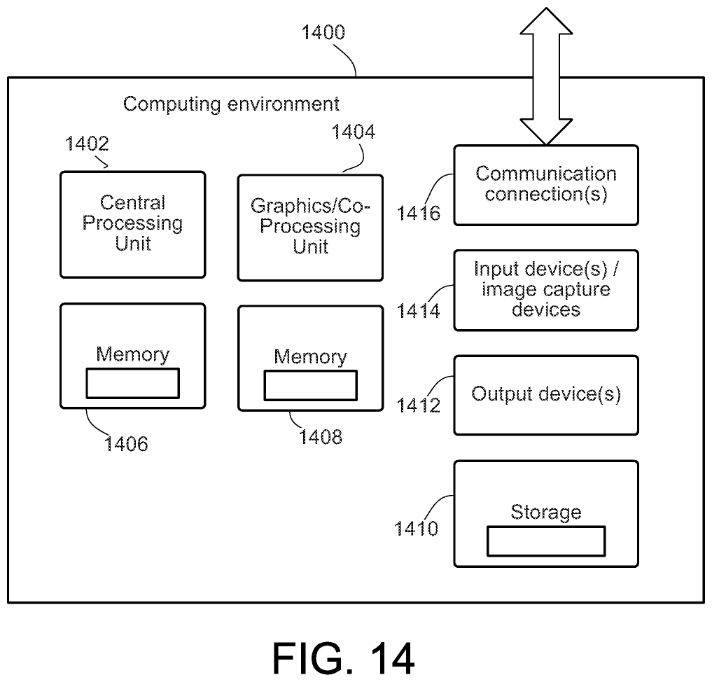

FIG. 14 illustrates a block diagram of an exemplary computing environment 1400 for an implementation of an RPA system, such as the RPA systems disclosed herein. The embodiments described herein may be implemented using the exemplary computing environment 1400. The exemplary computing environment 1400 includes one or more processing units 1402, 1404 and memory 1406, 1408. The processing units 1402, 1406 execute computer-executable instructions. Each of the processing units 1402, 1406 can be a general-purpose central processing unit (CPU), processor in an application-specific integrated circuit (ASIC) or any other type of processor. For example, as shown in FIG. 14, the processing unit 1402 can be a CPU, and the processing unit can be a graphics/co-processing unit (GPU). The tangible memory 1406, 1408 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1400 may be rearranged in various embodiments, and some embodiments may not require nor include all of the above components, while other embodiments may include additional components, such as specialized processors and additional memory.

The exemplary computing environment 1400 may have additional features such as, for example, tangible storage 1410, one or more input devices 1414, one or more output devices 1412, and one or more communication connections 1416. An interconnection mechanism (not shown) such as a bus, controller, or network can interconnect the various components of the exemplary computing environment 1400. Typically, operating system software (not shown) provides an operating system for other software executing in the exemplary computing environment 1400, and coordinates activities of the various components of the exemplary computing environment 1400.

The tangible storage 1410 may be removable or non-removable, and includes magnetic disks, magnetic tapes or cassettes, CD-ROMs, DVDs, or any other medium which can be used to store information in a non-transitory way, and which can be accessed within the computing system 1400. The tangible storage 1410 can store instructions for the software implementing one or more features of an RPA system as described herein.

The input device(s) or image capture device(s) 1414 may include, for example, one or more of a touch input device such as a keyboard, mouse, pen, or trackball, a voice input device, a scanning device, an imaging sensor, touch surface, or any other device capable of providing input to the exemplary computing environment 1400. For multimedia embodiment, the input device(s) 1414 can, for example, include a camera, a video card, a TV tuner card, or similar device that accepts video input in analog or digital form, a microphone, an audio card, or a CD-ROM or CD-RW that reads audio/video samples into the exemplary computing environment 1400. The output device(s) 1412 can, for example, include a display, a printer, a speaker, a CD-writer, or any another device that provides output from the exemplary computing environment 1400.

The one or more communication connections 1416 can enable communication over a communication medium to another computing entity. The communication medium conveys information such as computer-executable instructions, audio or video input or output, or other data. The communication medium can include a wireless medium, a wired medium, or a combination thereof.

This application also references U.S. patent application Ser. No. 17/096,908, filed Nov. 12, 2020, entitled “AUTOMATED SOFTWARE ROBOT CREATION FOR ROBOTIC PROCESS AUTOMATION”, which are expressly incorporated by reference herein. Additional details and description of processing of recordings, merging recordings, and producing software automation robots are described in this incorporated U.S. patent application Ser. No. 17/096,908.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for interrelating software robots of a robotic process automation system to carry out an automation workflow process, the method comprising:
identifying an automation workflow process to be performed, the automation workflow process including a sequence of tasks, the tasks including at least (i) one or more human tasks and (ii) one or more robotic tasks;
determining a first task within the automation workflow process that is to be performed;
causing the first task to be performed on a first computing device;
receiving an indication that the first task has completed;
determining a subsequent task within the automation workflow process that is to be performed after the first task;
causing the subsequent task to be performed on a second computing device; and
receiving an indication that the subsequent task has completed.

2. A computer-implemented method as recited in claim 1,
wherein the first computing device is required to be authorized to perform the first task,
wherein the second computing device is required to be authorized to perform the subsequent task, and
wherein the first computing device authorized to perform the subsequent task is different than the second computing device authorized to perform the first task, but both the first and second computing devices being associated with a single enterprise.

3. A computer-implemented method as recited in claim 1, wherein the first task is one of the one or more human tasks, and wherein the subsequent task is one of the one or more robotic tasks.

4. A computer-implemented method as recited in claim 1, wherein the first task is one of the one or more robotic tasks, and wherein the subsequent task is one of the one or more human tasks.

5. A computer-implemented method as recited in claim 1, wherein the automation workflow process is configured to direct that an input to the subsequent task is to be provided from an output produced by the first task.

6. A computer-implemented method as recited in claim 1, wherein the automation workflow process includes at least one conditional branch.

7. A computer-implemented method as recited in claim 1, wherein the automation workflow process includes conditional flow control for altering flow control of the automation workflow process based on conditional logic.

8. A computer-implemented method as recited in claim 1, wherein the first task is one of the one or more robotic tasks, and wherein the first task was previously configured to identify a software robot that the first task is to invoke, and
wherein the causing of the first task to be performed comprises causing the identified software robot to execute on the first computing device.

9. A non-transitory computer readable medium including at least computer program code tangible stored thereon for interrelating software robots of a robotic process automation system to carry out an automation workflow process, the computer readable medium comprising:
computer program code for identifying an automation workflow process to be performed, the automation workflow process including a sequence of tasks, the tasks including at least (i) one or more human tasks and (ii) one or more robotic tasks;
computer program code for determining a first task within the automation workflow process that is to be performed;
computer program code for causing the first task to be performed on a first computing device;
computer program code for receiving an indication that the first task has completed;
computer program code for determining a subsequent task within the automation workflow process that is to be performed after the first task;
computer program code for causing the subsequent task to be performed on a second computing device; and
computer program code for receiving an indication that the subsequent task has completed.

10. A computer-implemented method for interrelating software robots of a robotic process automation system to create an automation workflow process, the method comprising:
identifying a first human task to be included in the automation workflow process being created;
configuring the first human task to present a user interface to a person and to capture a data input therefrom;
identifying a first robotic task to be included in the automation workflow process being created;
arranging the first robotic task to follow after the first human task within the automation workflow process; and
configuring the first robotic task to utilize a first software robot, and to receive as an input at least a portion of the data input that the first human task provided.

11. A method as recited in claim 10, wherein the user interface presents an electronic form on a display for the person, and the person is able to input the data input using the user interface.

12. A method as recited in claim 10, wherein the method comprises:
identifying a first flow control condition to be included in the automation workflow process being created; and
arranging the first flow control condition to follow after the first robotic task within the automation workflow process.

13. A method as recited in claim 12,
wherein the first software robot, when performed, produces a result, and
wherein the method comprises:
configuring the first flow control condition to receive as a condition input at least the result produced by the first software robot.

14. A method as recited in claim 13, wherein the method comprises:
configuring the first flow control condition to compare the condition input to another value, and to produce a comparison result.

15. A method as recited in claim 14, wherein the method comprises:
configuring the first flow control condition to use a logical operator when comparing the condition input to another value.

16. A method as recited in claim 14, wherein the method comprises:
arranging the first flow control condition to cause process flow to follow either a first path or a second path dependent on the comparison result.

17. A method as recited in claim 16, wherein the method comprises:
arranging a second human task or a second robotic task to follow the first path.

18. A method as recited in claim 17, wherein the method comprises:
arranging a third human task or a third robotic task to follow the second path.

19. A method as recited in claim 16, wherein the method comprises:
arranging process flow following the first path to return to again perform the first human task or the first robotic task.

20. A non-transitory computer readable medium including at least computer program code tangible stored thereon for interrelating software robots of a robotic process automation system to create an automation workflow process, the computer readable medium comprising:
computer program code for identifying a human task to be included in the automation workflow process being created;
computer program code for configuring the human task to present a user interface to a person and to capture a data input therefrom;
computer program code for identifying a robotic task to be included in the automation workflow process being created;
computer program code for arranging the robotic task to follow after the human task within the automation workflow process; and
computer program code for configuring the robotic task to utilize a software robot.

21. A non-transitory computer readable medium as recited in claim 20, wherein the computer readable medium comprises:
computer program code for configuring the robotic task to receive as an input at least a portion of the data input that the first human task provided.

22. A robotic process automation system, comprising:
a data store configured to store a plurality of software robots, the software robots providing automated interaction with one or more software programs operating on one or more computing devices;
a workflow process platform configured to enable users to (i) create automation workflow processes, and (ii) perform automation workflow processes that have been created,
wherein at least a particular automation workflow process of the created automation workflow processes includes a determined sequence of performing a plurality of tasks, at least one of the tasks in the determined sequence being a robotic task that is performed by one of the software robots, and at least another of the tasks in the determined sequence being a human task that is performed to receive interaction with a person, and
wherein performance of the particular automation workflow process performs the tasks of the particular automation workflow process in the determined sequence, the performance including causing the one of the software robots for the robotic task to be performed and causing a user interface to be presented to the person in performing the human task.

23. A robotic process automation system as recited in claim 22, wherein, the workflow process platform manages the performance of the particular automation workflow process by operating to at least:
determine a first task within the particular automation workflow process that is to be performed;
cause the first task to be performed on a first computing device;
receive an indication that the first task has completed;
determine a subsequent task within the particular automation workflow process that is to be performed after the first task;
cause the subsequent task to be performed on a second computing device; and
receive an indication that the subsequent task has completed.

24. A robotic process automation system as recited in claim 22, wherein, in creating the particular automation workflow process via the workflow process platform, the workflow process platform is configured to at least:
identify a first task to be included in the automation workflow process being created;
identify a second task to be included in the automation workflow process being created; and
arrange the second task to follow after the first task within the automation workflow process.

25. A robotic process automation system as recited in claim 24, wherein, in creating the particular automation workflow process via the workflow process platform, the workflow process platform is configured to at least:
configure the first task to present a user interface to a person and to capture a data input therefrom; and
configure the second task to perform a first software robot, and to receive as an input at least a portion of the data input that the first task provided.

26. A computer-implemented method for interrelating software robots of a robotic process automation system to create an automation workflow process, the method comprising:
identifying a first robotic task to be included in the automation workflow process being created;
configuring the first robotic task to utilize a first software robot to obtain output data;
identifying a first human task to be included in the automation workflow process being created;
arranging the first human task to follow after the first robotic task within the automation workflow process; and
configuring the first human task to present a user interface to a person, wherein the user interface is used to present at least a portion of the output data obtained by the first robotic task.

27. A computer-implemented method as recited in claim 26, wherein the configuring of the first human task further configures the user interface to capture a data input from the person.
configuring the first robotic task to utilize a first software robot, and to receive as an input at least a portion of the data input that the first human task provided.
